(19) United States
(12) Patent Application Publication
(10) Pub. No.: US 2011/0209964 A1
(43) Pub. Date: Sep. 1, 2011

(54) WET CLUTCH

(75) Inventors: Mario Degler, Baden-Baden (DE); Stephan Maienschein, Baden-Baden (DE); Peter Droll, Karlsruhe (DE); Eugen Kombowski, Buehl (DE)

(73) Assignee: LUK VERMOEGENSVERWALTUNGSGESELLSCHAFT MBH, Buehl (DE)

(21) Appl. No.: 13/102,535

(22) Filed: May 6, 2011

Related U.S. Application Data
(63) Continuation of application No. PCT/DE2009/001531, filed on Oct. 29, 2009.

(30) Foreign Application Priority Data
Nov. 10, 2008 (DE) 102008056640.3

(51) Int. Cl. F16D 13/38

(52) U.S. Cl. 192/66.1

(57) ABSTRACT

A wet clutch (1) with at least one friction disk (8) that can be clamped by an axially displaceable piston (5) against an end disk (7). In order to provide a cost-effective and more silent design, the end disk is permanently attached at the housing. Several variants are proposed for the attachment of the end disk.

### CROSS-REFERENCE TO RELATED APPLICATIONS

This application is filed under 35 U.S.C. §120 and §365(c) as a continuation of International Patent Application No. PCT/DE2009/001531 filed Oc. 29, 2009 which application claims priority from Germany Patent Application No. 10 2008 056 640.3 filed on Nov. 10, 2008 which applications are incorporated herein by reference in their entirety.

### FIELD OF THE INVENTION

The invention relates to a wet clutch with at least one friction disc that is loadable by a piston relative to an end disc.

### BACKGROUND OF THE INVENTION

Wet clutches are known e.g. from DE 10 2007 053 974 A1 as converter lockup clutches for hydrodynamic torque converters, as separate wet clutches, as startup clutches or as twin clutches for twin clutch transmissions. Thus plural friction discs associated with an input side and an output side of the wet clutch are stacked in an alternating manner to form a disc packet and are received torque-proof and axially moveable with limits on two radially offset disc supports as a function of their input side or output side association. Thus, an end disc is arranged on a disc support. An axial travel of the end disc is limited at a stop of the disc support. The disc packet is pressed or clamped against the end disc by an axially moveable pressure loadable piston for torque transfer through the wet clutch. By receiving the end disc on the disc support and axially supporting it at this location a particular configuration can cause noise, in particular when there is no load or in a load range of the drive unit with small to medium torque. Furthermore the deformation properties of the end disc that is not fixated axially can cause undesirable disadvantages on the load. Eventually the cost for an inner and an outer disc carrier is comparatively high.

### BRIEF SUMMARY OF THE INVENTION

Thus, it is the object of the invention to provide a wet clutch which is cost-effective, low noise and suitable for transferring high torque.

The object is achieved through a wet clutch with a housing driven by a drive unit and with at least one friction disc that is configured to be clamped against an end disc through a piston that is axially moveable through a pressure. The end disc is axially and radially fixed and received torque-proof at a housing. Through this attachment of the end disc at the housing a radially outer disc support can be omitted. Additionally, higher torques can be transferred through the diameter, thus achievable with the same number of friction discs due to the larger friction diameter of the friction discs. A smaller number of friction discs can be used for the same transferable torque. Where necessary the input side friction discs can also be engaged at accordingly provided circumferential profiles like inner teethings of the housing. Through omitting the outer disc support lower noise configurations can be proposed since e.g. the interior of the wet clutch can be configured in a more homogenous manner.

Thus, it has proven particularly advantageous when the end disc is not welded, but received through form locking or friction locking Thus, the attachment of the end disc with the respect to the movement degrees of freedom of the non-connected end disc relative to the housing can be provided through different attachment methods. In particular, for movement degrees of freedom in axial direction and in circumferential direction the same or different friction locking or form locking methods can be used.

For example, a torque transfer of the end disc, thus an attachment of the end disc in circumferential direction relative to the housing, can be provided through friction locking in that the end disc is radially clamped relative to the housing in that the end disc is pressed into the inner circumference of the housing or attached forming a plastic deformation of the housing and/or the end disc. Alternatively, form locking can be provided between the end disc and the housing in that the end disc is radially or axially cut into the housing. Furthermore, profiles that are complementary to one another like material recesses, recesses or threads like fine threads, standard threads or trapezoid threads can be provided.

The axial fixation of the end disc can be provided e.g. in case of friction locking through impressing or forming a plastic connection or in case of form locking through a plastic connection. Furthermore, when forming the housing from two housing shells, one housing shell, e.g. the pump of a torque converter, can be used as an axial stop for the friction disc.

In order to provide a plastic deformation between the end disc and the housing the end disc, the housing, e.g. one of the two housing shells, or both housing shells can be deformed plastically.

In order to configure the connection furthermore, the end disc and the housing can be caulked together. Alternatively, the housing can be roller-burnished about the end disc. The end disc can be permanently inserted into the housing through a wobbling process. The housing can be deformed through forging or embossing, so that the end disc can be permanently received in the housing. In another advantageously configured embodiment, an end disc can be provided that is riveted together with the housing. In particular, for cost reasons and for maintaining tightness of the housing, seal buds can protrude from the housing at which the end disc is riveted together with the housing.

A plastic deformation for attaching the end disc at the housing can thus be provided completely over the entire circumference and/or in sections by providing circular segments that are distributed over the circumference. A plastic deformation is provided at the circular segments. For example the end disc can be received through friction locking like e.g. through roller-burnishing over the entire circumference for torque-proof reception and can be caulked along the circumference in segments or partially for axial attachment to the housing.

The end disc can have a planar, conical or dish shape. Thus, the dish-shaped end disc can be partially applied to the housing. In particular for stabilizing the end disc beads, embossings and/or ribs can be provided thereon. Furthermore, the end disc can include at least one material recess at least at one of its circumferences or radially there between. Material recesses of this type can be provided through holes, punching, teething and/or notching and can be used for better flow through of pressure medium for controlling the piston and/or cooling the friction discs, in particular their liners.

Furthermore it has proven advantageous to vary the material thickness of the friction disc. Thus in particular material thicknesses can be advantageous that vary over the radius of the end disc. Thus e.g. a higher stiffness can be achieved for minimum material use.

### BRIEF DESCRIPTION OF THE SEVERAL VIEWS OF THE DRAWING

The nature and mode of operation of the present invention will now be more fully described in the following detailed description of the invention taken with the accompanying drawing figures, in which:

FIG. 1 illustrates a wet clutch with an end disc with an axial stop and plastically generated friction locking in rotation direction;

FIG. 2 illustrates a wet clutch with an end disc with an axial stop and teething in rotation direction;

FIG. 3 illustrates a wet clutch with an end disc provided with holes;

FIG. 4 illustrates a wet clutch with a riveted end disc;

FIG. 5 illustrates a wet clutch with a notched end disc;

FIG. 6 illustrates a wet clutch with a caulked end disc; and

FIG. 7 illustrates a wet clutch with an end disc that is caulked in an alternative manner compared to the embodiment of the wet clutch of FIG. 6.

### DETAILED DESCRIPTION OF THE INVENTION

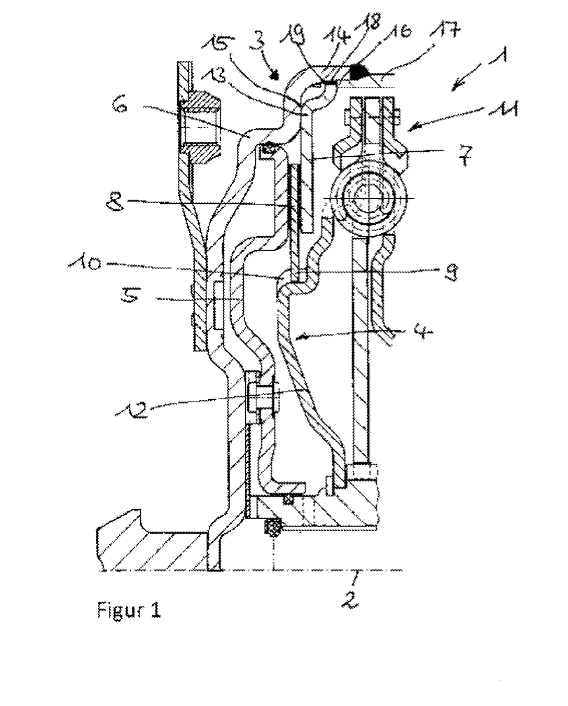

FIG. 1 illustrates the upper half of the wet clutch 1 arranged about the rotation axis 2. The wet clutch 1 is formed from an input component 3 and an output component 4. The input component 3 includes the piston 5 connected torque-proof with the housing 6 that is moveable within limits relative to the housing. The input component 3 includes the end disc 7 permanently received at the housing. The output component 4 forms the friction disc 8 that is clampable between the piston 5 and the end disc 7. The friction disc is connected torque-proof through the inner teething 9 with the input component 12 of the torsion vibration damper 11 through an outer teething 10 embossed in the input component 12.

The end disc 7 is received at the housing 6 in an axially fixated and torque-proof manner. Thus, the end disc is configured dish-shaped and axially fixed on one side through a radially inner radially extending portion 13 at a radially extended portion 15 with shoulders of the housing shell 14 of the housing 6. In the other direction the end disc 7 is axially fixed at a stop 16 of the housing shell 17 that is radially reduced relative to the inner diameter of the housing shell 14. The two housing shells 14, 15 are welded together during final assembly and form the housing 6 of the wet clutch 1, wherein the housing shell 17 can simultaneously form the pump of the torque converter when using the wet clutch 1 as a converter lockup clutch.

After installing the piston 5 and the friction disc 8 the end disc 7 is inserted torque-proof through a plastic deformation 18 of the inner surface of the housing shell 14 of the housing 6. Thus, a fine profile 19 can be fabricated at the inner surface of the housing shell 14. The fine profile has a smaller inner diameter than the outer diameter of the end disc 7. When axially inserting the end disc 7 at the stop of the portion 15, the fine profile 19 of the housing shell 14 is plastically deformed and a frictional engagement is formed, so that the end disc 7 is rotationally fixated and after completing the remaining inner portions of the housing 6 the housing shell 17 is axially fixated at the housing 6 through the stop 16.

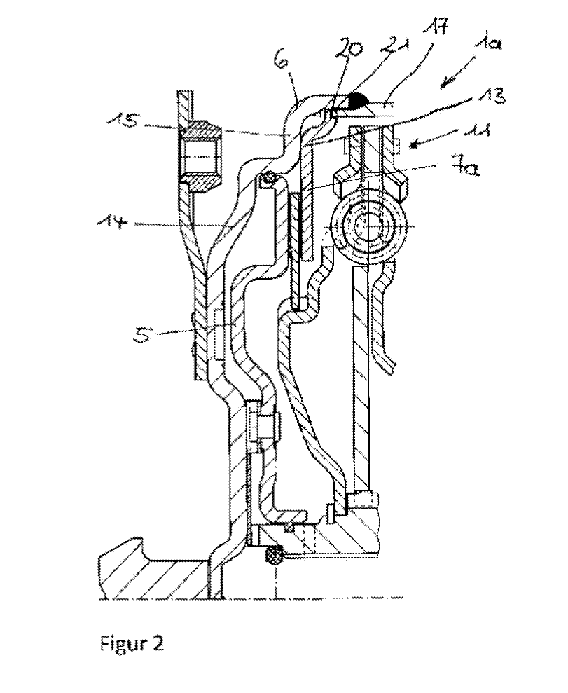

FIG. 2 illustrates an embodiment of a similar wet clutch 1A that is an alternative to the wet clutch 1 of FIG. 1. Differently from the wet clutch FIG. 1 the end disc 7A is received in a form locking manner at the housing 6. Thus, the outer circumference of the end disc 7A includes an axial teething 20 which is in engagement with a face teething 21 of the housing shell 17. Thus, the face teething 21 simultaneously forms the stop for the end disc 7a in the direction of the torsion vibration damper 11. In a direction of the piston 5 the radial portion 15 of the housing shell 14 forms an axial stop for the radially inner portion 13 of the dish shaped end disc 7a. The end disc 7a is thus inserted into the housing shell 14 and centered at the inner circumference of the housing shell 14. The form locking to the housing shell 14 is thus configured when joining the two housing shells 14, 17.

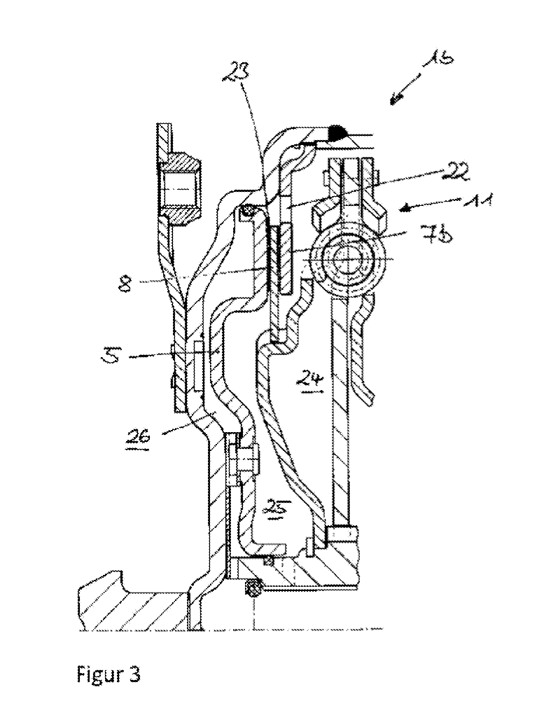

FIG. 3 illustrates a wet clutch lb that is similar to the wet clutch 1 of FIG. 1 with the difference that the end disc 7b includes at least a recess 22 like e.g. a punched out recess. Besides mass savings at the end disc 7b the recesses 22 facilitate an improved exchange of pressure medium for cooling the friction liners 23 of the friction disc 8. Thus, a separation into the pressure chambers 25, 26 is provided for accordingly configured wet clutches or in a three channel torque converter, wherein the separation takes over the cooling and the activation of the wet clutch 1b (also of the remaining illustrated wet clutches). For closing the wet clutch 1b the pressure chamber 26 is loaded with a pressure medium with higher pressure than the pressure applied to the pressure chamber 25. Thus the piston 5 moves axially and loads the friction disc 8 against the end disc 7B so that a frictional engagement is formed between the two components and torque is transferred to the torsion vibration damper 11. Additionally the pressure of the pressure cavity 24 is increased over the pressure of the pressure cavity 25 and a pressure medium flow is provided over the recess 22 and the friction liners 23 wherein the pressure medium flow cools the friction liners 23.

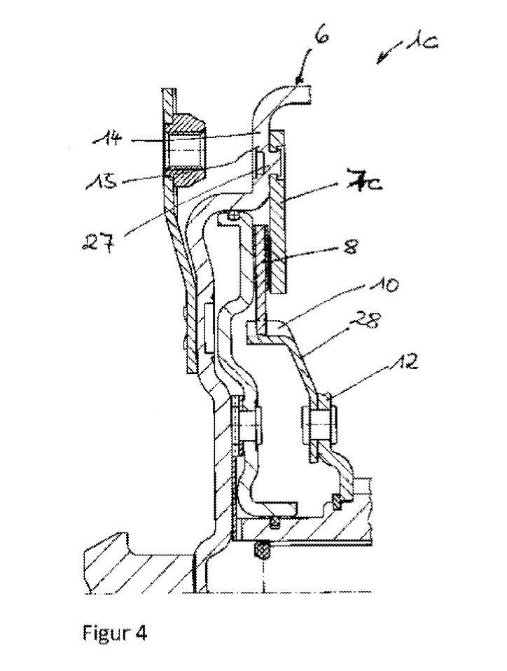

FIG. 4 illustrates an embodiment of a wet clutch 1c in which the end disc 7c is riveted radially outside the friction disc 8 at the radially aligned portion 15 of the housing shell 14 of the housing 6 and is thus attached torque proof or axially fixed and in a centered manner at the housing 6. In the illustrated embodiment, the rivets 27 are formed from rivet buds which are pressed out of the housing shell 14. In the following the only partially illustrated input component 12 of the non-illustrated torsion vibration damper and the disc support 28 with the outer teething for torque proof connection of the friction disc 8 are configured in two portions.

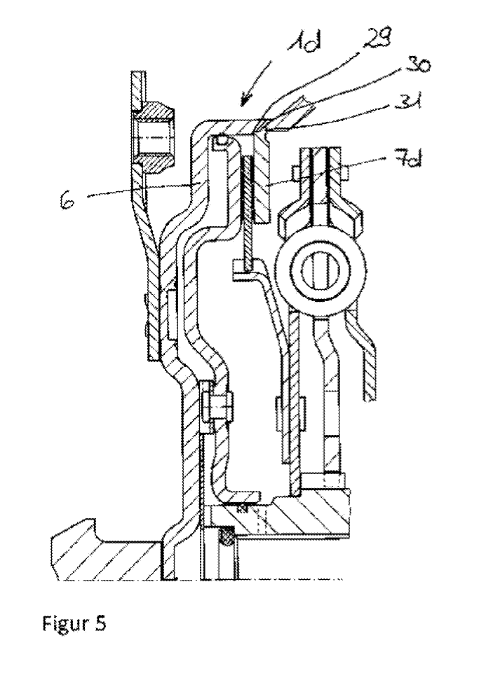

FIG. 5 illustrates the wet clutch ld in which the end disc 7d in the housing 6 is fixed through material displacement of the end disc 7d in an axially fixated and torque-proof manner. An axial stop 29 is thus configured in the housing 6 for axially contacting the end disc 7d. A circumferential groove 30 can be provided at the housing 6 into which material of the end disc 7d in the form of an annular protrusion 31 is displaced into the annular groove 30 through axial force loading through one or plural rollers distributed over the circumference or through a pressure loaded chisel. Differently from the end discs 7, 7a, 7b of FIGS. 1 through 3 the end disc 7d is configured planar in the illustrated embodiment.

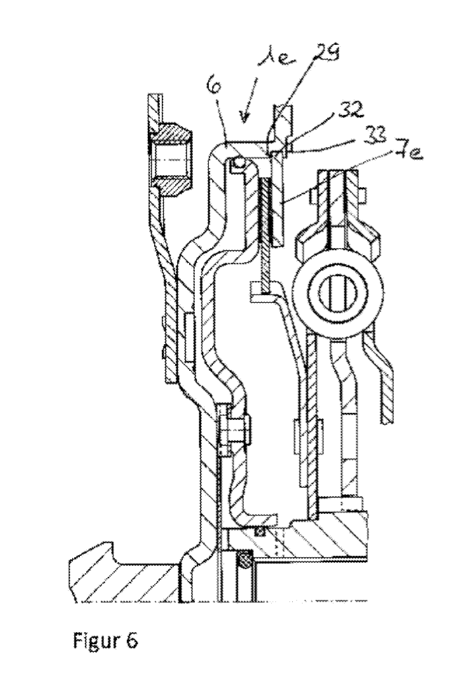

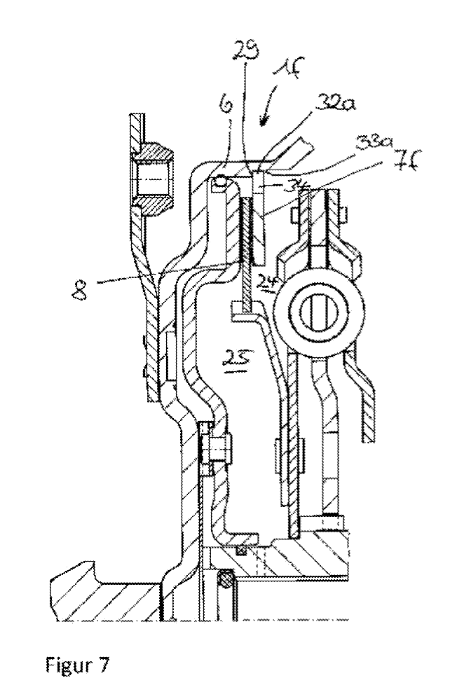

FIGS. 6 and 7 illustrate wet clutches le and if in which the end discs 7e, 7f that are configured planar are respectively caulked with the housing 6 in axial direction. The end discs 7e, 7f thus include an outer profile like an outer teething 32, 32a which forms a form locking engagement with an inner profile that is provided in a complementary manner in the inner circumference of the housing 6 so that the end disc 7e, 7f is received torque-proof in the housing 6. After applying the end disc 7e, 7f at the stop 29 of the housing 6 the end disc 7e, 7f is caulked with the housing 6 for axial safety. Thus, caulking lugs 33 are formed through radially displacing material of the housing 6 in the wet clutch le of FIG. 6. The caulking lugs are distributed over the circumference. The caulking lugs 33a are formed in the wet clutch if of FIG. 7 through an axial displacement of material of the housing 6. As evident e.g. from the view of the end disc 7F of FIG. 7, the outer teething 32a of the end discs can include relief openings 34 through which pressure medium balancing can be provided between the pressure cavities 24, 25 for cooling the friction disc 8. In order to increase the torque that is transferrable through the connection of the end disc 7f and the housing 6, the material displacements of the housing 6 can at least partially reach over the relief openings 34.

### REFERENCE NUMERALS AND DESIGNATIONS

1 Wet clutch

1a Wet clutch

1b Wet clutch

1c Wet clutch

1d Wet clutch

1e Wet clutch

1f Wet clutch

2 Rotation axis

3 Input component

4 Output component

5 Piston

6 Housing

7 End disc

7a End disc

7b End disc

7c End disc

7d End disc

7e End disc

7f End disc

8 Friction liner

9 Inner teething

10 Outer teething

11 Torsion vibration damper

12 Input component

13 Portion

14 Housing shell

15 Portion

16 Stop

17 Housing shell

18 Plastic deformation

19 Fine profile

20 Axial teething

21 Face teething

22 Recess

23 Friction liner

24 Pressure cavity

25 Pressure cavity

26 Pressure cavity

27 Rivet

28 Disc support

29 Stop

30 Circumferential groove

31 lug

32 Outer teething

32a Outer teething

33 Caulking lug

33a Caulking lug

34 Relief opening

What we claim is:

1. A wet clutch comprising a housing (6) driven by a drive unit and at least one friction liner (8) configured to be clamped against an end disc (7, 7a, 7b, 7c, 7d, 7e, 7f) through a piston (5) that is axially movable through pressure, wherein the end disc (7, 7a, 7b, 7c, 7d, 7e, 7f) is supported in an axially, radially and rotationally fixated manner at the housing (6).

2. The wet clutch according to claim 1, wherein the end disc (7, 7a, 7b, 7c, 7d, 7e, 7f) is circumferentially supported through friction locking or form locking at the housing (6).

3. The wet clutch according to claim 1, wherein the end disc (7, 7a, 7b, 7c, 7d, 7e, 7f) is axially supported through friction- or form locking at the housing (6).

4. The wet clutch according to claim 1, wherein the end disc (7, 7a, 7b, 7c, 7d, 7e, 7f) is permanently connected with the housing through impressing or through a plastic deformation.

5. The wet clutch according to claim 1, wherein the end disc (7, 7a, 7b, 7c, 7e, 7f) is axially fixated at a stop (16, 29) formed by at least one of two housing shells (14, 17) of the housing (6).

6. The wet clutch according to claim 1, wherein the end disc (7e, 7f) is caulked with the housing (6).

7. The wet clutch according to claim 1, wherein the housing (6) is roller-burnished relative to the end disc (7d).

8. The wet clutch according to claim 1, wherein the end disc (7c) is riveted together with the housing (6).

9. The wet clutch according to claim 1, wherein the end disc is attached at the housing through a wobble process.

10. The wet clutch according to claim 1, wherein the end disc is supported at the housing through a forging- or embossing process.

11. The wet clutch according to claim 1, wherein the end disc (7, 7a, 7b, 7d) is received over its entire circumference at the housing (6).

12. The wet clutch according to claim 1, wherein the end disc (7e, 7f) is supported relative to the housing (6) in circumferential segments at least with respect to one degree of freedom of motion freedom.

13. The wet clutch according to claim 1, wherein the end disc (7, 7a, 7b, 7c, 7d, 7e, 7f) has a planar, conical or dish shape.

14. The wet clutch according to claim 1, wherein end disc includes beads, embossings, and/or ribs.

15. The wet clutch according to claim 1, wherein the end disc (7b, 7e, 7f) includes at least one recess (22) or relief opening (34) at least at one circumference of the end disc or radially between circumferences of the end disc.

16. The wet clutch according to claim 1, wherein a material thickness varies over the circumference or in radial direction.
